(19) United States
(12) Patent Application Publication
(10) Pub. No.: US 2004/0019517 A1
(43) Pub. Date: Jan. 29, 2004

(54) Method of establishing an insurable value estimate for a real estate property

(75) Inventor: Mark Sennott, Sherborn, MA (US)

Correspondence Address: FOLEY AND LARDNER, SUITE 500, 3000 K STREET NW, WASHINGTON, DC, 20007, US

(73) Assignee: Fidelity National Information Solutions, Inc.

(21) Appl. No.: 10/202,849

(22) Filed: Jul. 26, 2002

(51) Int. Cl. G06F 17/60

(52) U.S. Cl. 705/10

(57) ABSTRACT

A method of providing a real estate property value estimate for a subject property through the use of an automated value model, where the method comprises: identifying known data concerning the subject property, determining whether the known data is sufficient to allow an automated valuation model to return a provisional value estimate for the subject property, in the event that the known data is not sufficient, then performing research required to identify sufficient known data and to identify relevant comparable properties, sufficient to enable the automated valuation model to return a reliable value estimate, and validating the existence of the subject property by physically examining it via an inspection.

### BACKGROUND OF THE INVENTION

A. Field of the Invention

The present invention is directed to the field of value estimation methods for real estate properties. Specifically the invention is directed to a method for facilitating the 100% usage of automated value models (AVMs) to provide reliable estimates of the real estate property values so they can be insured.

B. Description of the Related Art

One of the objectives in a transaction involving real estate is to cover all risks of the interested parties with insurance. For example, real estate transactions often include title insurance, flood and tax certifications, and mortgage insurance. One of the required elements of a mortgage transaction relating to a real estate property is having an appraisal of the value of the property itself. In order to be able to insure a real estate property's appraised value, insurers involved in such mortgage transaction need to know that the property value was determined with a high degree of objectivity and accuracy.

Quite often, appraisals performed using traditional appraisal methods, such as using human appraisers to determine the market value of a property, are too subjective for insurance purposes. The basic appraisal process can be described as evaluating the subject property, selecting comparable transactions, and determining a value for the subject property by applying scaling factors to the comparable values. Human judgment enters into the calculation in determining what transactions are comparable, what scaling factors to use, and the effect of other factors such as conformity of subject property to the neighborhood, the view from the property and the quality of the school district. From an insurer's perspective, such appraisals include too much of a human appraiser's judgement and subjectivity to be objective.

Automated value models (AVMs) are used in the real estate industry to provide value estimations based on observable and concrete factors. Such AVMs are considered by insurers to be providing real estate property value estimations which, from an insurer's perspective, are sufficiently reliable and objective to form the basis of an insurance policy on the value of property. One example of current AVM methodology is Freddie Mac's Home Value Estimator (HVE). The HVE produces a computer-generated estimate of value by entering subject property characteristics, comparable sales in the immediate area of the subject, and other data into a proprietary regression model to produce an estimate of value. While this AVM and other competing models like it have gained substantial acceptance in the marketplace, these AVM models also have noticeable shortcomings.

One of the problems identified by the inventor is that many properties are not conducive to having value estimations performed using the above-mentioned automated valuation models. In these cases, the data required by the AVM regarding the property may be unavailable, incomplete or obsolete. For example, a house that burned down last month, may still be carried in a database from which the AVM obtains property data. Another problem is that the subject property characteristics or comparable sales data is not readily available. The lack of data or the availability of poor data result in only an estimated 50% of purchase mortgage transaction having sufficient database coverage to permit an AVM to produce an estimate. Even within this 50% “hit rate”, insufficient or inaccurate data can lead to unreliable estimates of value, thus making the insuring of such estimates difficult.

Another problem identified by the inventor is that the very lack of human involvement, which provides the AVM with more objectivity, can seriously undermine the reliability of the value estimates generated by the AVM. For example, patterns of value are often not susceptible to mechanistic analysis. AVMs commonly select comparable properties in geographic proximity to the subject property, e.g. within a 0.25 mile radius, but it is generally true that crossing a highway or railroad track can place one in an entirely different value area; the AVM may have difficulty identifying such a transition. Also, AVMs have trouble recognizing the quality of a view or other intangible factors.

The result is that, currently, AVMs are not accepted as the primary sources of property value estimates in the purchase money mortgage market, which constitutes over half of all mortgages established each year in the United States.

### SUMMARY OF THE INVENTION

Having identified the aforementioned problems in the existing methods of value estimation, the inventor has developed the method of the present invention. As described in the present application, the invention provides for real estate value estimations of such quality and consistency that they may be relied upon for insurance purposes and does so in a way which is advantageous to traditional appraisal methods. The method developed by the inventor is quicker, less expensive, more reliable and more consistent than traditional methods using a human appraiser. More importantly, the inventor's method also increases the use of AVM methodologies so that 100% of all residential properties can be estimated by using AVMs or AVM methodology, thereby allowing for insurance coverage.

The present invention discloses a method of providing a real estate property value estimate for a subject property through the use of an automated value model, where the method comprises: identifying known data concerning the subject property, performing a desktop evaluation of the subject property by searching electronic databases to collect data regarding the subject property, preparing a validating report including performing a drive-by inspection to collect data regarding the subject property, and running an automated value model to generate a real estate property value estimate for the subject property.

The present invention also provides a method for establishing a reliable estimate of the value of a subject real estate property, comprising the steps of: identifying known data concerning the subject property, determining whether the known data is sufficient to allow an automated valuation model to return a provisional value estimate for the subject property, in the event that the known data is not sufficient, then performing research required to identify sufficient known data and to identify relevant comparable properties, sufficient to enable the automated valuation model to return a reliable value estimate, and validating the existence of the subject property by physically examining it via an inspection.

Other features and advantages of the present invention will become apparent to those skilled in the art from the following detailed description. It should be understood, however, that the detailed description and specific examples, while indicating preferred embodiments of the present invention, are given by way of illustration and not limitation. Many changes and modifications within the scope of the present invention may be made without departing from the spirit thereof, and the invention includes all such modifications.

### BRIEF DESCRIPTION OF THE DRAWINGS

The foregoing advantages and features of the invention will become apparent upon reference to the following detailed description and the accompanying drawings, of which:

FIG. 1 is flowchart illustrating the preferred embodiment of the method of the present invention;

FIG. 2 illustrates a field inspection report in accordance with the preferred embodiment of the present invention;

FIG. 3 illustrates a desktop AVM report in accordance with the preferred embodiment of the present invention; and

FIG. 4 illustrates a field data collection AVM report in accordance with the preferred embodiment of the present invention.

### DETAILED DESCRIPTION OF THE INVENTION

The present invention is now described in detail with reference to the above-mentioned figures. The present invention can be summarized as a method of providing a real estate property value estimate for a subject property through the use of an automated value model (AVM) by ensuring that there is enough data for an AVM to be run.

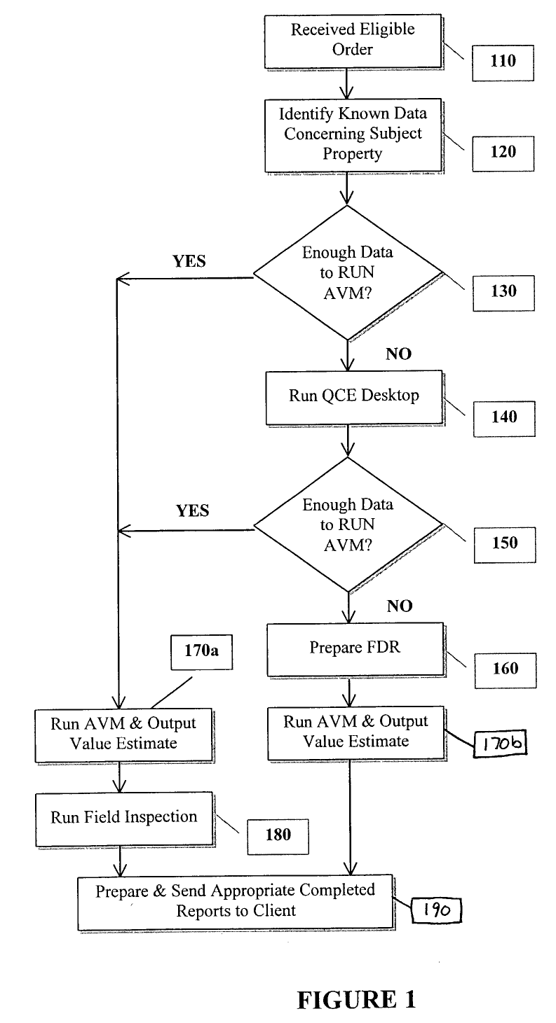

FIG. 1 is flowchart illustrating the preferred embodiment of the method of the present invention. Step 110 shows that the process is initiated when an eligible order for a value estimate is received. The order identifies the subject real estate property and other relevant information, including the desired mortgage amount. The requirements for eligibility can be determined by the user of the present invention. For example, eligibility can be based on the loan amount whereby loans under a certain amount are deemed eligible for automated valuation. In practice, some mortgages, particularly those over a certain amount, require physical appraisal to be compliant with Federal Regulation (FIRREA). Under this example, such mortgages are ineligible for value estimation using AVMs and the method of the present invention.

Step 120 illustrates the identification of the known data concerning the subject property. Actually, there are two sets of data of interest: one pertaining directly to the subject property and another pertaining to comparable properties in the area from which value determinations can be based. Such data includes assessed price, last sale price, lot size, last sale date, room counts and gross living area. So when information is being collected, it is useful to collect information regarding both of these sets of data for both subject and comparable properties. Comparables are selected based on similarity of size and age, recency of sale and proximity.

In the present invention, as shown in Step 130 of FIG. 1, after known data concerning the subject property has been identified, a determination is made as to whether there is enough data to run the AVM. If there is, the AVM is run in Step 170A and the value estimation is output.

For the purposes of the present description, a “hit” is the condition where there is enough data on a given real estate property for the particular AVM to be run to generate a value estimation for that property. Conversely, a “no hit” is the condition where there is insufficient data on a given real estate property for the particular AVM to be run to generate a value estimation for that property. Whether there is sufficient data or not can vary depending upon the particular AVM used.

If, in Step 130, it is determined that there is not enough data to run the AVM, i.e. a “no hit” condition, the method of the present invention progresses to the next step of a desktop evaluation as shown in Step 140. This step is also known as performing a quick collateral evaluation (QCE). This step involves a person manually trying to find enough data to fill in the gaps so that there is sufficient data to run the AVM. This person physically searches various databases and other sources of information to obtain data regarding the subject property and the identified comparable properties. These information sources may include the Internet, proprietary third-party databases, and personal relationships with companies such as banks which may have relevant information on the subject and/or comparable properties. In the preferred embodiment, this step is done by a person because such sources do not have a common interface to facilitate automated searching. However, it will be apparent to one skilled in the art that some if not all of such searching could be done automatically. As much data as can be collected by a person from his/her “desktop” is collected. Other sources of information which can be accessed by the person in this step include the local multiple listing service (MLS) to obtain data on both the subject property and the identified comparable properties.

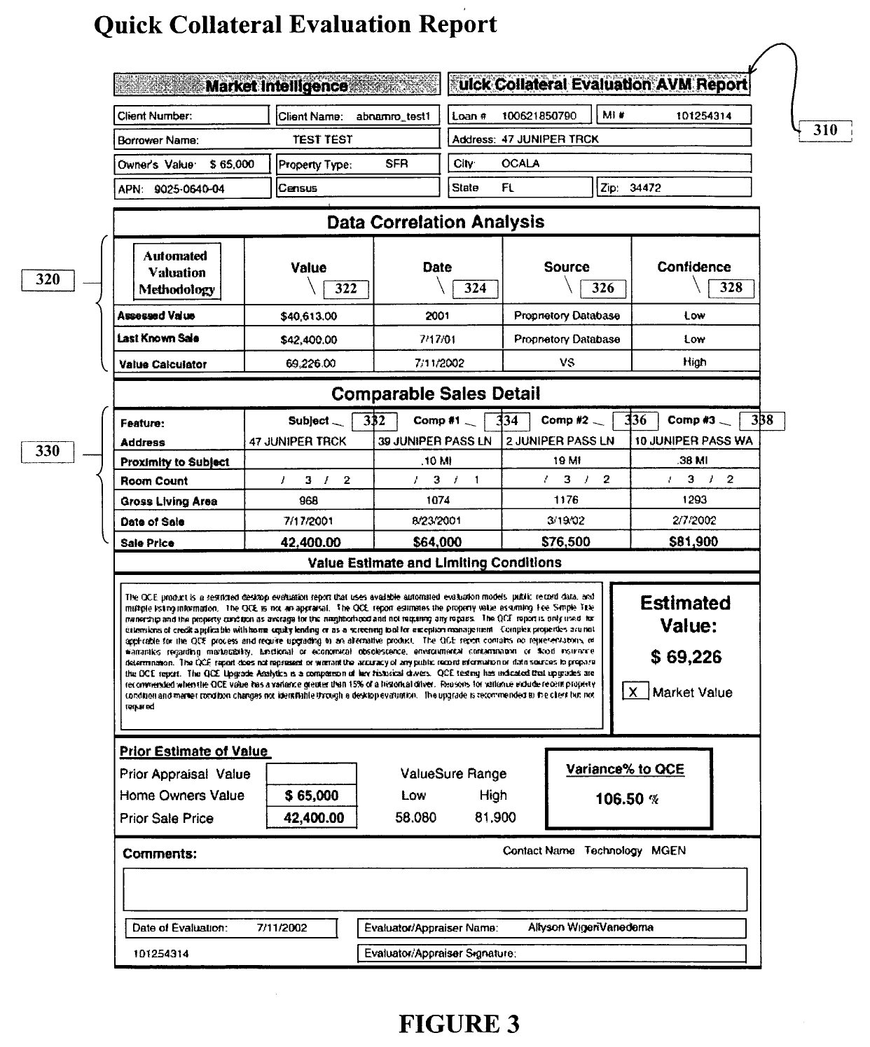

A sample of a report generated by the end of step 140 is shown as element 310 in FIG. 3. This report shows data used by the AVM to generate a value estimate. Various valuation figures are identified as elements 320 and include the properties' assessed value and last known sale price. The report also shows four categories of information for each of these figures as elements 322-328. For example, element 322 shows the value in dollars, element 324 shows the date corresponding to such value, element 326 shows the source of such information, and element 328 shows the confidence level of such information. The report also shows information regarding the comparison of the subject property to identified comparable properties. Elements 330 show various types of information regarding each of such properties. Such information includes proximity to the subject property, room count, gross living area, date of sale, and the sales price. In this report, the information corresponding to the subject property is shown in column 332 whereas similar information regarding comparable properties, in this case three comparable properties, is shown in columns 334, 336 and 338. It will be apparent to one skilled in the art that the configuration and contents of the report shown as element 310 is provided by way of example and does limit the scope of the invention.

After this step 140 has been completed, the expected hit rate is 50%. That is, in 50% of the cases involving purchase money home mortgages, there would be enough data at this stage to run an AVM. Step 150 in FIG. 1 illustrates the determination as to whether there is enough data at this stage to run the AVM. If there is, the method of the present invention proceeds directly to step 170A. The AVM is run and the value estimate is output.

In addition to identifying the known data in step 120, according to the method of the present invention and as shown as step 180, a field inspection is performed for the subject property.

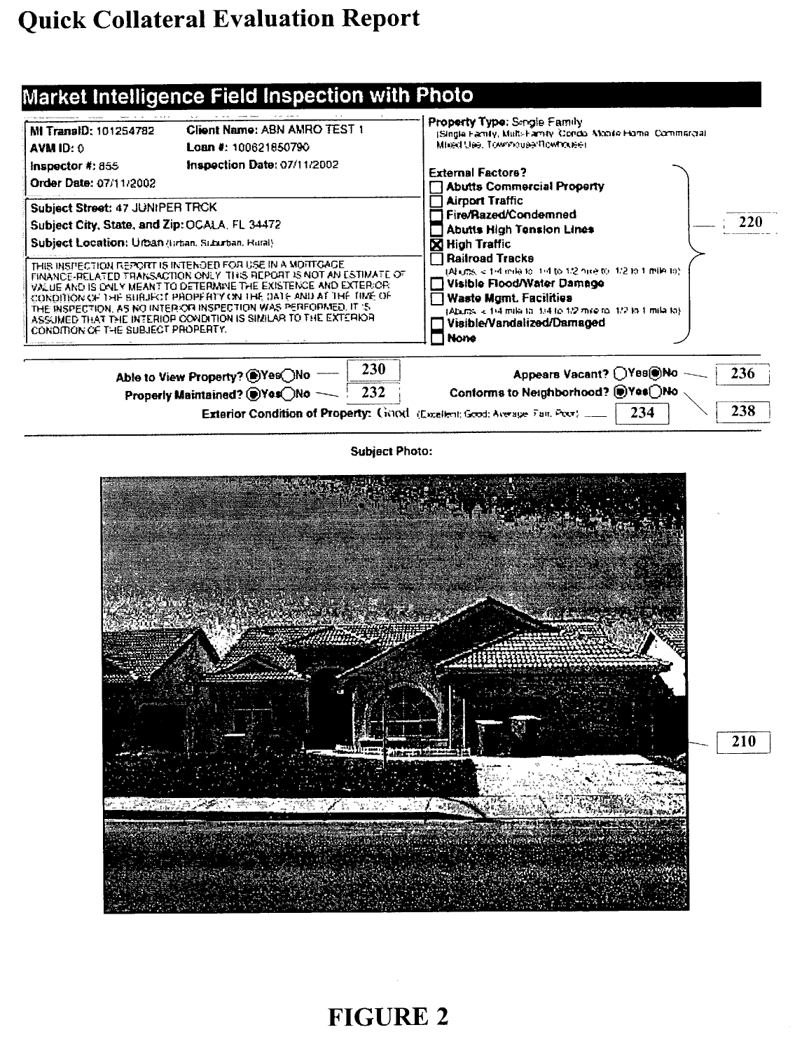

The inventor has recognized that certain factors will affect the value of a property but are missing from the AVM process. In accordance with the present invention, a field inspection is performed to assess and document these factors, as shown in step 180 of FIG. 1. A person, known as a field inspector, physically goes to the subject property to perform the field inspection and prepares a field inspection report as shown in FIG. 2. In the preferred embodiment of the invention, this person is part of a nation wide network. Using a nation wide network allows for a person who is local to the subject property to be able to perform the field inspection without great expense.

One of the aspects of performing the field inspection is obtaining a current photograph of the exterior of the property. In the preferred embodiment, this photograph is taken digitally and is electronically incorporated with the field inspection report. An example of such photograph is shown as element 210 in FIG. 2.

The person conducting the field inspection objectively determines whether certain factors are present in the subject property. These are factors which may affect the value of the property but are not normally included in the AVM process. In the preferred embodiment of the invention, the field inspection report contains a check list of such factors as shown in negative value factors 220 and external condition factors 230-238. The actual factors chosen can be determined by the user and do not limit the scope of the present invention. In the preferred embodiment of the invention, the negative value factors 220, that is those factors which are likely to decrease the value of the property, include whether the property abuts commercial property, whether there is a presence of airport traffic near the subject property, whether the property has been subjected to fire, has been razed or condemned, whether the property abutts high tension lines, whether there is a presence of high traffic near the property, the proximity of the property to railroad tracks, whether there is any visual flood or water damage of the property, the proximity of the property to waste management facilities, whether there is any visual damage or vandalization to the property, or whether there are no such negative value factors.

In addition, the field inspector assesses certain external condition factors as shown as elements 230-238 in FIG. 2. Such factors include whether the field inspector was able to view the property, whether the property was maintained, the exterior condition of the property using a limited number of gradations, whether the property appears vacant and whether the property conforms to the neighborhood. This information having been collected and including the photograph of the subject property, comprises the field inspection report which can then be sent electronically to the requesting party.

The effect of the field inspection is to address property condition data not available to the AVM. The report also addresses the problem of the time lag between when the data for the AVM was collected to the present condition of the property. For example, the field inspection report will recognize recent fire damage to the property whereas the data available to the AVM may not. Such discrepancies may otherwise render the value estimation meaningless. Using the field inspection report, serves to improve the reliability of the value estimation.

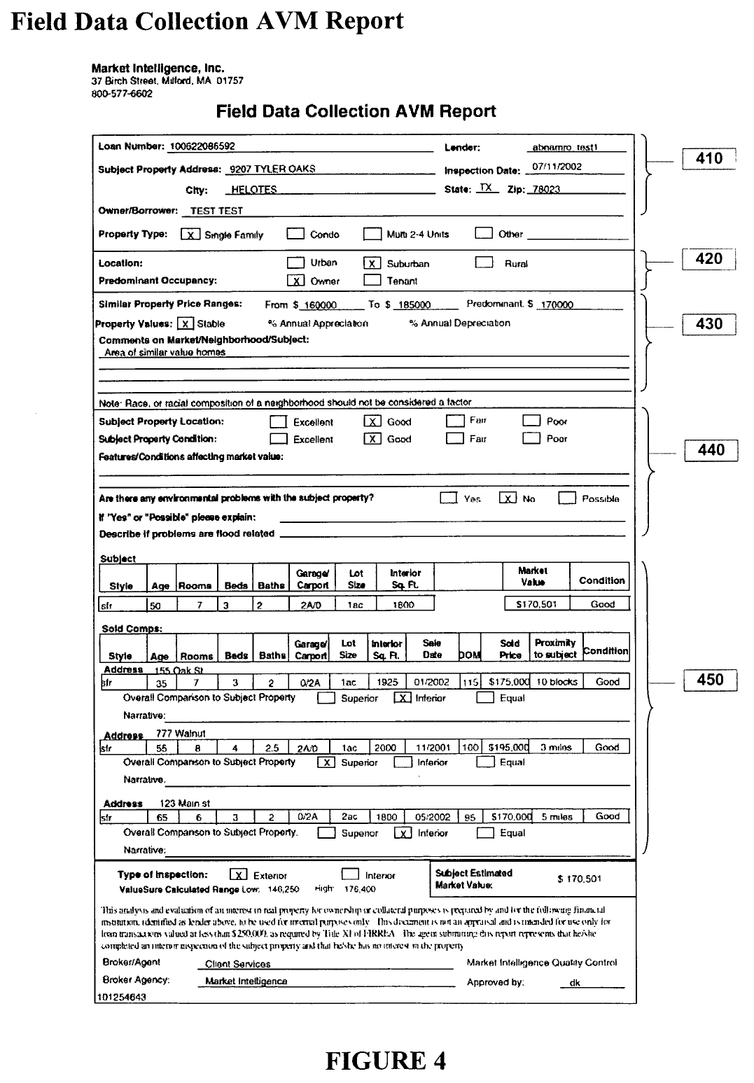

If in step 150 it is determined that there is not enough data to run the AVM the method progresses to step 160 which is the preparation of a Field Data Collection AVM Report (FDR). This step involves sending a person to the property to collect further information. This is an information gathering exercise not to be confused with an appraisal. The person performing the inspection in completing the FDR need not be trained and/or licensed in appraising. Accordingly, this step can be performed inexpensively compared to an appraisal. A sample FDR is illustrated as element 410 in FIG. 4 and will be discussed in greater detail herein. In addition to the low cost, one of the benefits of performing the FDR is that it does not have the subjectivity connected with an appraisal since the person completing the FDR is simply gathering facts and information and not making subjective evaluations. This is important for insurance purposes as subjective appraisals are often uninsurable.

The person performing the FDR will physically visit the property. The form used by the person conducting the FDR contains much of the information and many of the same questions attempted to be answered by the previous steps. It facilitates the collection of information regarding the subject property and identified comparable properties. For example, element 420 shows where the person conducting the FDR can indicate the type of location of the property such as “urban,” and the predominant occupancy of the property such as “owner occupied.” Element 430 shows where information regarding similar properties and the neighborhood surrounding the subject property can be entered. For example, such information includes: similar property price ranges, the stability of property values in the area, and comments on the market and neighborhood in which the subject property is located. Element 440 shows where information regarding the subject property location and condition can be entered. For example, the person conducting the FDR can indicate the desirability of the subject property location in one of four gradations, from “poor” to “excellent.” Similarly, the condition of the subject property can be rated in one of the four gradations. The inherent subjectivity of such rating is tempered by the fact that there are a limited number of possible responses making it likely that the rating will be objective and not depend on the person conducting the FDR. Another factor addressed in this section is whether there are any obvious environmental problems with the subject property. Element 450 shows information regarding the subject property and the identified comparable properties for comparison purposes. As with the QCE report described above, the configuration and contents of the FDR report shown as element 410 in FIG. 4 is for purposes of example only and does not limit the scope of the invention.

After completion of the FDR the hit rate in almost all cases is 100%. That is, according to the method of the present invention, once the FDR has been prepared, one is almost guaranteed to have enough information to run an AVM and to generate a value estimate which will be viewed as reliable and therefore insurable. Accordingly, step 170B in FIG. 1 shows that after the FDR is prepared in step 160 the AVM can be run.

Both the field inspection report and the FDR can be used to validate the data available to the AVM. Using these reports, and particularly a report in which existing data is validated, serves to improve the reliability of the value estimation generated by the AVM in steps 170A and 170B.

Finally, step 190 illustrates that once the AVM has been run and the value estimate has been output, an, if applicable, the filed inspection has been run, the completed report is prepared and sent to the requesting client.

Thus, a method of providing a real estate property value estimate for a subject property through the use of an automated value model by ensuring that there is enough data for an AVM to be run has been described according to the present invention. Many modifications and variations may be made to the techniques described and illustrated herein without departing from the spirit and scope of the invention. Accordingly, it should be understood that the methods described herein are illustrative only and are not limiting upon the scope of the invention. It should be noted that although the flow chart provided herein shows a specific order of method steps, it is understood that the order of these steps may differ from what is depicted. Also two or more steps may be performed concurrently or with partial concurrence.

What is claimed is:

1. A method for establishing an insurable estimate of the value of a subject real estate property, comprising the steps of:
identifying known data concerning the subject property;
determining whether the known data is sufficient to allow an automated valuation model to return a provisional value estimate for the subject property;
in the event that the known data is not sufficient, then performing research required to identify sufficient known data and to identify relevant comparable properties, sufficient to enable the automated valuation model to return a reliable value estimate; and
validating the value estimate by physically examining the subject property.

2. A method of providing a real estate property value estimate for a subject property according to claim 1, wherein the step of validating the value estimate further comprises generating a field inspection report and obtaining a photograph of the subject property for inclusion in the field inspection report.

3. A method of providing a real estate property value estimate for a subject property according to claim 2, wherein said step of generating a field inspection report further comprises determining the presence or absence of a plurality of negative value factors regarding the subject property for inclusion in the field inspection report.

4. A method of providing a real estate property value estimate for a subject property according to claim 2, wherein said step of generating a field inspection report further comprises confirming a plurality of external condition factors regarding the subject property for inclusion in the field inspection report.

5. A method of providing a real estate property value estimate for a subject property according to claim 1, wherein said step of performing research further comprises searching non-public sources of information for data on the subject property.

6. A method of providing a real estate property value estimate for a subject property according to claim 1, wherein said step of performing research further comprises contacting banks to obtain data on the subject property.

7. A method of providing a real estate property value estimate for a subject property according to claim 1, wherein said step of performing research further comprises searching one or more multiple listing services (MLS) to obtain data on at least one of the subject property and a comparable property.

8. A method of providing a real estate property value estimate for a subject property according to claim 1, wherein said step of performing research further comprises performing a physical inspection of the subject property.

9. A method of providing a real estate property value estimate for a subject property through the use of an automated value model, said method comprising:
a) identifying known data concerning the subject property;
b) performing a desktop AVM evaluation of the subject property by searching electronic databases to collect data regarding the subject property;
c) preparing a validating report including performing a drive-by inspection to collect data regarding the subject property;
d) running an automated value model to generate a real estate property value estimate for the subject property.

10. A method of providing a real estate property value estimate for a subject property according to claim 9, wherein step b) is only performed when the known data after step a) is insufficient to allow an automated valuation model to return a value estimate for the subject property.

11. A method of providing a real estate property value estimate for a subject property according to claim 9 wherein step c) is performed after step d) and step b) is skipped when the known data after step a) is sufficient to allow an automated valuation model to return a value estimate for the subject property and wherein said validating report is a field inspection report used to validate said generated real estate property value estimate.

12. A method of providing a real estate property value estimate for a subject property according to claim 9 wherein said validating report is a field data collection report used to validate said generated real estate property value estimate.

13. A method of providing a real estate property value estimate for a subject property according to claim 9, wherein steps b) and c) further comprise collecting data on at least one comparable property relative to the subject property.

14. A method of providing a real estate property value estimate for a subject property according to claim 9, wherein step b) further comprises searching non-public sources of information for data on the subject property.

15. A method of providing a real estate property value estimate for a subject property according to claim 9, wherein step b) further comprises contacting banks to obtain data on the subject property.

16. A method of providing a real estate property value estimate for a subject property according to claim 9, wherein step b) further comprises searching one or more multiple listing services (MLS) to obtain data on the subject property.

17. A method of providing a real estate property value estimate for a subject property according to claim 9, wherein step c) further comprises performing a physical inspection of the subject property.

18. A method of providing a real estate property value estimate for a subject property according to claim 9, wherein step c) further comprises physically entering the subject property to collect data regarding the same.

19. A method of providing a real estate property value estimate for a subject property according to claim 9, wherein step c) further comprises obtaining a photograph of the subject property for inclusion in the field inspection report.

20. A method of providing a real estate property value estimate for a subject property according to claim 9, wherein step c) further comprises determining the presence or absence of a plurality of negative value factors regarding the subject property for inclusion in the field inspection report.

21. A method of providing a real estate property value estimate for a subject property according to claim 9, wherein step c) further comprises confirming a plurality of external condition factors regarding the subject property for inclusion in the field inspection report.
